(19) United States
(12) Patent Application Publication
(10) Pub. No.: US 2014/0259189 A1
(43) Pub. Date: Sep. 11, 2014

(54) REVIEW SYSTEM

(71) Applicant: QUALCOMM INCORPORATED, San Diego, CA (US)

(72) Inventor: Krishnan RAMACHANDRAN, San Diego, CA (US)

(73) Assignee: QUALCOMM Incorporated, San Diego, CA (US)

(21) Appl. No.: 13/793,817

(22) Filed: Mar. 11, 2013

(51) Int. Cl. H04L 29/06

(52) U.S. Cl. CPC H04L 63/08
USPC 726/30

(57) ABSTRACT

Techniques are provided for counteracting bias in reviews by authenticating and/or weighing the reviews based on the user-specific context. For instance, the reviews may be authenticated based on the user's location and the relative position of the user with respect to other users. For example, a number of users sitting at a movie theater in an arc shape for an extended period of time may indicate that the users are watching a movie at the movie theater. Techniques described herein may provide the users with an interface to provide a review for the movie theater as the users break the arc formation indicating completion of the movie. In another example, reviews of content such as media clips, using a device, may also be authenticated and/or weighed based on the user-specific context. The user-specific context, such as the lighting conditions, the time of day of the review, etc., can indicate the level of detail that the user examined the content with and provide a metric for authenticating and/or weighing the reviews.

### BACKGROUND

Aspects of the disclosure relate to computing technologies, such as systems, methods, apparatuses, and computer-readable media for improving the reliability of reviews for content.

Reviews for content, such as food at a restaurant, an article or an establishment help consumers make informed choices based on experiences of other users. However, current review systems have very little or no means of counteracting biased reviews for content submitted over the internet by users. For instance, a person may be biased against a competitor's restaurant and may rate the competitor's restaurant low with disparaging remarks without ever visiting the restaurant. Similarly, users may have a natural bias while reviewing content, such as media clips on a mobile device, based on factors other than the content of the media clip itself, such as the source or of the media clip or how the user received the media clip. For example, the user may rate an article very low based on the newspaper it is associated with or if it was forwarded by a friend that usually sends the user materials that the user does not like. In such instances, the user may review and rate the content without even reading the article.

### BRIEF SUMMARY

Techniques are provided for counteracting bias in reviews by authenticating and/or weighing the reviews based on the user-specific context. For instance, the reviews may be authenticated based on the user's location and the relative position of the user with respect to other users. For example, a number of users sitting at a movie theater in an arc shape for an extended period of time may indicate that the users are watching a movie at the movie theater. Techniques described herein may provide the users with an interface to provide a review for the movie theater as the users break the arc formation indicating completion of the movie. In another example, reviews of content such as media clips, using a device, may also be authenticated and/or weighed based on the user-specific context. The user-specific context, such as the lighting conditions, the time of day of the review, etc., can indicate the level of detail that the user examined the content with and provide a metric for authenticating and/or weighing the reviews.

An example method for authenticating a user-specific context in a process to submit a review for content may include determining the user-specific context using one or more context-related parameters, and authenticating that the user-specific context is a proper context for submitting the review for the content. In one implementation, the one or more context-related parameters comprise at least a first context-related parameter indicative of a location of a first mobile device and a second context-related parameter indicative of a positioning of the first mobile device relative to a second mobile device, and wherein determining the user-specific context using the one or more context-related parameters includes accessing the first context-related parameter indicative of the location of the first mobile device, accessing the second context-related parameter indicative of a positioning of the first mobile device relative to the second mobile device, and determining the user-specific context using the location of the first mobile device and the positioning of the first mobile device relative to the second mobile device.

In one or more embodiments, the following features may be implemented. For instance, the location may be one or more of location address, location name, location tag, location coordinates, and contextual information indicative of the location. The content may be one or more of a location, a social gathering, a business, an activity at the business, an event, a local attraction, an article or a portion of the article, and a media clip or a portion of the media clip. In one implementation, authenticating the review for the content may comprises determining that a user performed an activity associated with the review, wherein determining that the user performed the activity is based on the context-related parameters. In another implementation, authenticating the review for the content comprises determining that a user completed an activity associated with the review, wherein determining that the user completed the activity is based on the context-related parameters. The activity may include an altered positioning of a first mobile device relative to a second mobile device and wherein detecting completion of the activity comprises detecting an increase in distance in relative position of the first mobile device with respect to the second mobile device beyond a distance threshold. Completion of the activity further may include detecting the increase in the distance beyond the distance threshold for a time period beyond a time threshold.

In additional aspects of the disclosure, the method may include authenticating the user-specific context prior to generating a user interface to submit the review for the content. The method may also include generating a user interface to submit the review for the content, and initiating an unauthenticated review process if the user-specific context is not authenticated. Furthermore, the method may weigh the review for the content based on the user-specific context.

Weighing the review may include associating a higher weight with a group review than a non-group review, wherein the group review is the review generated by a first mobile device associated with a group activity. The group activity may include associating the first mobile device with a group of mobile devices participating in the same activity as a group. The method may further implemented for determining if a group performing the group activity is a known group by using social networking information or previously formed associations between the first mobile device and other mobile devices from the group and weighing the review for the group review based on information associated with the known group. Weighing the review may also be based on user-specific context of the review that includes determining reliability of the review for the content based on the user-specific context of the review, and weighing the review based on the determined reliability of the review.

In some implementations of the method, the context-related parameter are one or more of determining frequency of visits to a location being reviewed, detecting time spent by a user reviewing the content, determining time of day at which the content is reviewed, determining completeness of the review of the content, determining consumability of the content that is being reviewed, determining user's past behavior while reviewing similar content, detecting eye gaze of the user to determine if the user was viewing the content, determining if a device is properly oriented towards the user for viewing of the content, determining location of the user, determining activity the user is engaged in while reviewing the content, determining relation between the content and reviewer, and determining specificity of the review.

An example device, such as a server, may comprise one or more processors configured for authenticating a user-specific context in a process to submit a review for content may include determining the user-specific context using one or more context-related parameters, and authenticating that the user-specific context is a proper context for submitting the review for the content. In one implementation, the one or more context-related parameters comprise at least a first context-related parameter indicative of a location of a first mobile device and a second context-related parameter indicative of a positioning of the first mobile device relative to a second mobile device, and wherein determining the user-specific context using the one or more context-related parameters includes accessing, by the one or more processors, the first context-related parameter indicative of the location of the first mobile device, accessing, by the one or more processors, the second context-related parameter indicative of a positioning of the first mobile device relative to the second mobile device, and determining, by the one or more processors, the user-specific context using the location of the first mobile device and the positioning of the first mobile device relative to the second mobile device.

In one or more embodiments, the following features may be implemented. For instance, the location may be one or more of location address, location name, location tag, location coordinates, and contextual information indicative of the location. The content may be one or more of a location, a social gathering, a business, an activity at the business, an event, a local attraction, an article or a portion of the article, and a media clip or a portion of the media clip. In one implementation, authenticating the review for the content may comprises determining, by the one or more processors, that a user performed an activity associated with the review, wherein determining that the user performed the activity is based on the context-related parameters. In another implementation, authenticating the review for the content comprises determining, by the one or more processors, that a user completed an activity associated with the review, wherein determining that the user completed the activity is based on the context-related parameters. The activity may include an altered positioning of a first mobile device relative to a second mobile device and wherein detecting completion of the activity comprises detecting an increase in distance in relative position of the first mobile device with respect to the second mobile device beyond a distance threshold. Completion of the activity further may include detecting, by the one or more processors, the increase in the distance beyond the distance threshold for a time period beyond a time threshold.

In additional aspects of the disclosure, the device may be configured for authenticating, by the one or more processors, the user-specific context prior to generating a user interface to submit the review for the content. The device may also be configured for generating a user interface to submit the review for the content, and initiating an unauthenticated review process if the user-specific context is not authenticated. Furthermore, the device may weigh the review for the content based on the user-specific context.

Weighing the review may include associating a higher weight with a group review than a non-group review, wherein the group review is the review generated by a first mobile device associated with a group activity. The group activity may include associating the first mobile device with a group of mobile devices participating in the same activity as a group. The device may be further configured for determining, by the one or more processors, if a group performing the group activity is a known group by using social networking information or previously formed associations between the first mobile device and other mobile devices from the group and weighing the review for the group review based on information associated with the known group. Weighing the review may also be based on user-specific context of the review that includes determining reliability of the review for the content based on the user-specific context of the review, and weighing the review based on the determined reliability of the review.

In some implementations of the device, the context-related parameter are one or more of determining frequency of visits to a location being reviewed, detecting time spent by a user reviewing the content, determining time of day at which the content is reviewed, determining completeness of the review of the content, determining consumability of the content that is being reviewed, determining user's past behavior while reviewing similar content, detecting eye gaze of the user to determine if the user was viewing the content, determining if a device is properly oriented towards the user for viewing of the content, determining location of the user, determining activity the user is engaged in while reviewing the content, determining relation between the content and reviewer, and determining specificity of the review.

A non-transitory computer readable storage medium coupled to a processor, wherein the non-transitory computer readable storage medium comprises a computer program executable by the processor for authenticating a user-specific context in a process to submit a review for content may include determining the user-specific context using one or more context-related parameters, and authenticating that the user-specific context is a proper context for submitting the review for the content. In one implementation, the one or more context-related parameters comprise at least a first context-related parameter indicative of a location of a first mobile device and a second context-related parameter indicative of a positioning of the first mobile device relative to a second mobile device, and wherein determining the user-specific context using the one or more context-related parameters includes accessing the first context-related parameter indicative of the location of the first mobile device, accessing the second context-related parameter indicative of a positioning of the first mobile device relative to the second mobile device, and determining the user-specific context using the location of the first mobile device and the positioning of the first mobile device relative to the second mobile device.

In one or more embodiments, the following features may be implemented. For instance, the location may be one or more of location address, location name, location tag, location coordinates, and contextual information indicative of the location. The content may be one or more of a location, a social gathering, a business, an activity at the business, an event, a local attraction, an article or a portion of the article, and a media clip or a portion of the media clip. In one implementation, authenticating the review for the content may comprises determining that a user performed an activity associated with the review, wherein determining that the user performed the activity is based on the context-related parameters. In another implementation, authenticating the review for the content comprises determining that a user completed an activity associated with the review, wherein determining that the user completed the activity is based on the context-related parameters. The activity may include an altered positioning of a first mobile device relative to a second mobile device and wherein detecting completion of the activity comprises detecting an increase in distance in relative position of the first mobile device with respect to the second mobile device beyond a distance threshold. Completion of the activity further may include detecting the increase in the distance beyond the distance threshold for a time period beyond a time threshold.

In additional aspects of the disclosure, the non-transitory computer readable storage medium may include instructions for authenticating the user-specific context prior to generating a user interface to submit the review for the content. The non-transitory computer readable storage medium may also include instructions for generating a user interface to submit the review for the content, and initiating an unauthenticated review process if the user-specific context is not authenticated. Furthermore, the non-transitory computer readable storage medium may include instructions to weigh the review for the content based on the user-specific context.

Weighing the review may include associating a higher weight with a group review than a non-group review, wherein the group review is the review generated by a first mobile device associated with a group activity. The group activity may include associating the first mobile device with a group of mobile devices participating in the same activity as a group. The non-transitory computer readable storage medium may further include instructions for determining if a group performing the group activity is a known group by using social networking information or previously formed associations between the first mobile device and other mobile devices from the group and weighing the review for the group review based on information associated with the known group. Weighing the review may also be based on user-specific context of the review that includes determining reliability of the review for the content based on the user-specific context of the review, and weighing the review based on the determined reliability of the review.

In some implementations of the non-transitory computer readable storage medium, the context-related parameter is one or more of determining frequency of visits to a location being reviewed, detecting time spent by a user reviewing the content, determining time of day at which the content is reviewed, determining completeness of the review of the content, determining consumability of the content that is being reviewed, determining user's past behavior while reviewing similar content, detecting eye gaze of the user to determine if the user was viewing the content, determining if a device is properly oriented towards the user for viewing of the content, determining location of the user, determining activity the user is engaged in while reviewing the content, determining relation between the content and reviewer, and determining specificity of the review.

An example device for authenticating a user-specific context in a process to submit a review for content may include means for determining the user-specific context using one or more context-related parameters, and means for authenticating that the user-specific context is a proper context for submitting the review for the content. In one implementation, the one or more context-related parameters comprise at least a first context-related parameter indicative of a location of a first mobile device and a second context-related parameter indicative of a positioning of the first mobile device relative to a second mobile device, and wherein determining the user-specific context using the one or more context-related parameters includes means for accessing the first context-related parameter indicative of the location of the first mobile device, means for accessing the second context-related parameter indicative of a positioning of the first mobile device relative to the second mobile device, and means for determining the user-specific context using the location of the first mobile device and the positioning of the first mobile device relative to the second mobile device.

In one or more embodiments, the following features may be implemented. For instance, the location may be one or more of location address, location name, location tag, location coordinates, and contextual information indicative of the location. The content may be one or more of a location, a social gathering, a business, an activity at the business, an event, a local attraction, an article or a portion of the article, and a media clip or a portion of the media clip. In one implementation, authenticating the review for the content may comprises means for determining that a user performed an activity associated with the review, wherein means for determining that the user performed the activity is based on the context-related parameters. In another implementation, authenticating the review for the content comprises means for determining that a user completed an activity associated with the review, wherein means for determining that the user completed the activity is based on the context-related parameters. The activity may include an altered positioning of a first mobile device relative to a second mobile device and wherein detecting completion of the activity comprises means for detecting an increase in distance in relative position of the first mobile device with respect to the second mobile device beyond a distance threshold. Completion of the activity further may include detecting the increase in the distance beyond the distance threshold for a time period beyond a time threshold.

In additional aspects of the disclosure, the device may include means for authenticating the user-specific context prior to generating a user interface to submit the review for the content. The device may also include means for generating a user interface to submit the review for the content, and initiating an unauthenticated review process if the user-specific context is not authenticated. Furthermore, the device may include means for weighing the review for the content based on the user-specific context.

Means for weighing the review may include associating a higher weight with a group review than a non-group review, wherein the group review is the review generated by a first mobile device associated with a group activity. The group activity may include means for associating the first mobile device with a group of mobile devices participating in the same activity as a group. The device may further implement a means for determining if a group performing the group activity is a known group by using social networking information or previously formed associations between the first mobile device and other mobile devices from the group and weighing the review for the group review based on information associated with the known group. Means for weighing the review may also be based on user-specific context of the review that includes means for determining reliability of the review for the content based on the user-specific context of the review, and means for weighing the review based on the determined reliability of the review.

In some implementations of the device, the context-related parameter are one or more of determining frequency of visits to a location being reviewed, detecting time spent by a user reviewing the content, determining time of day at which the content is reviewed, determining completeness of the review of the content, determining consumability of the content that is being reviewed, determining user's past behavior while reviewing similar content, detecting eye gaze of the user to determine if the user was viewing the content, determining if a device is properly oriented towards the user for viewing of the content, determining location of the user, determining activity the user is engaged in while reviewing the content, determining relation between the content and reviewer, and determining specificity of the review.

The foregoing has outlined rather broadly the features and technical advantages of examples according to the disclosure in order for the detailed description that follows to be better understood. Additional features and advantages will be described hereinafter. The conception and specific examples disclosed can be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages, will be better understood from the following description when considered in connection with the accompanying figures. Each of the figures is provided for the purpose of illustration and description only and not as a definition of the limits of the claims.

### BRIEF DESCRIPTION OF THE DRAWINGS

The following description is provided with reference to the drawings, where like reference numerals are used to refer to like elements throughout. While various details of one or more techniques are described herein, other techniques are also possible. In some instances, well-known structures and devices are shown in block diagram form in order to facilitate describing various techniques.

A further understanding of the nature and advantages of examples provided by the disclosure can be realized by reference to the remaining portions of the specification and the drawings, wherein like reference numerals are used throughout the several drawings to refer to similar components. In some instances, a sub-label is associated with a reference numeral to denote one of multiple similar components.

FIG. 1 is a block diagram, illustrating modules that may be used in performing embodiments of the invention.

FIG. 2 is a simplified flow diagram, illustrating a method 200 for performing one embodiment of the invention.

FIG. 3 is another simplified flow diagram, illustrating a method 300 for performing one embodiment of the invention.

FIG. 4 is an example configuration of mobile devices indicating an activity performed by the users of the devices.

FIG. 5A and FIG. 5B illustrate an additional example configuration for the activity performed by the users of the devices.

FIG. 6 illustrates an example configuration indicating completion of a group activity by the users.

FIG. 7 is an example embodiment of the invention for reviewing an article using the device.

FIG. 8 is a simplified flow diagram, illustrating an example method 800 for retaining desirable images.

FIG. 9 is an example system diagram, illustrating a plurality of devices interacting with the network.

FIG. 10 illustrates an example device in which one or more aspects of the disclosure may be implemented.

### DETAILED DESCRIPTION

Techniques according to the current disclosure may provide a number of benefits compared to existing techniques. Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

Embodiments of the invention describe techniques for improving results of a review system. In one embodiment, the review system described herein describes techniques for counteracting user bias while reviewing content. A review may refer to an evaluation of content, such as a media clip, an article, a publication, a product, a service, a company, a location, an establishment or a live event. A review may include a written or verbal evaluation, response to survey questions or a rating of the content. A rating may be an evaluation or assessment of something, in terms of quality, quantity, or some combination of both. In some implementations, a rating may be a numerical evaluation, for instance, on a scale from 1-10.

In one embodiment, the review system automatically triggers an interface for the user based on the user-specific context for receiving real-time or near real-time reviews from the user. In one implementation, the review system detects the user's presence at a particular location and also infers the user's activity. The user's activity may be inferred using the relative position of the various mobile devices to each other. In one aspect, a completion of an activity may trigger a user interface for submitting a review automatically on a user's mobile device.

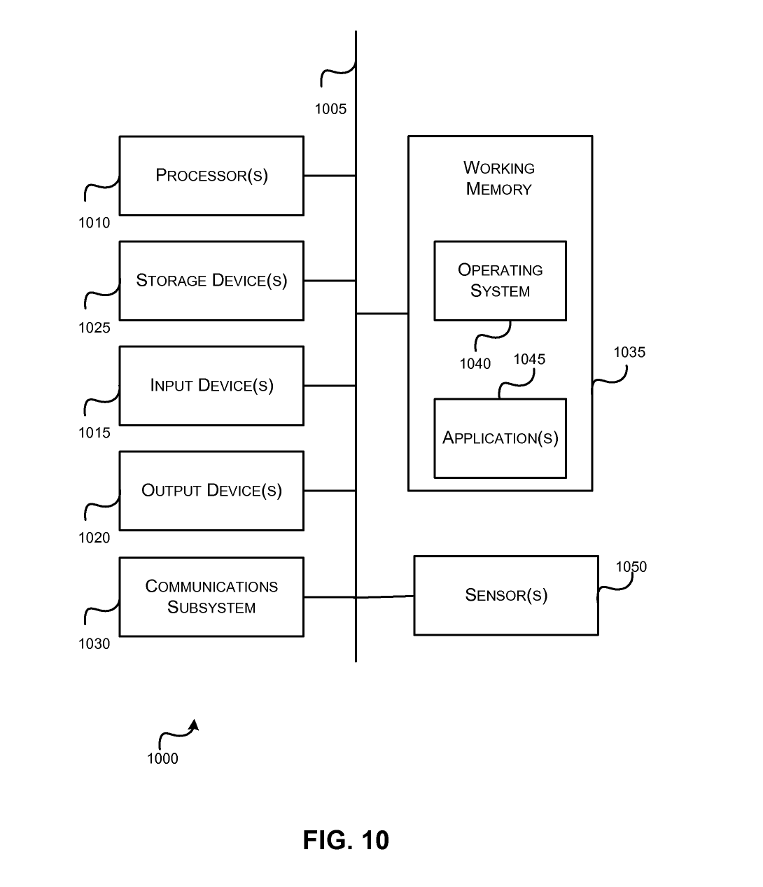

A mobile device may be any computing device, such as device 1000 shown in FIG. 10. Device 1000 may include one or more input sensory unit or input devices 1015 such as sensors 1050 and one or more input/output devices such as a display unit or a touch screen. Examples of a computing device 1000 include, but are not limited to, video game consoles, tablets, smart phones, laptops, netbooks, or other portable devices.

The review system may detect an activity pattern of a user at a particular place and offer an interface to the user at the completion of activity in real time. For example, if users of the system visits a restaurant and provides a review, the system may determine the nature of the activity performed by the user (e.g., lunch at restaurant, drink at bar, game at billiards table, etc.). Once the completion of the activity is detected an interface may be provided to the group of users involved in the activity through their devices to enter and submit a review.

Embodiments of the invention, may offer several advantages. For instance, embodiments of the invention may drastically reduce fraudulent reviews and improve the overall quality of the reviews and rating provided by the review system. For example, competitors would not be able to easily submit false reviews without actually visiting an establishment and performing the activity that triggers the review process. Also, employees at the establishment would not be able to enter favorable reviews just by visiting the facility, as they regularly would for work. To submit a review the employees would actually have to engage in the same activity as any other user would have to before submitting a review, making it impractical to continually submit fake reviews to artificially inflate the restaurant's rating. Similarly, embodiments of the invention may facilitate automatic check-in at a particular location, for loyalty programs, without the necessity of user's interaction, based on user's privacy settings. Furthermore, the user interface is provided in real time to the users making the reviews more accurate, reliable and timely.

In another embodiment, the review system improves the accuracy of the ratings and review for content reviewed over a device, such as a media clip or an article, based on the user-specific context. In addition, the review system may infer the level of attention the user commits to the details of the contents in reviewing the content, in weighing the rating and review received from the user. In one implementation, the weighing of the reviews results in normalization of reviews over time and different user-contexts. The weighted accumulation of the ratings and reviews may be used by the search engines to appropriately generate and display results most relevant to a search query.

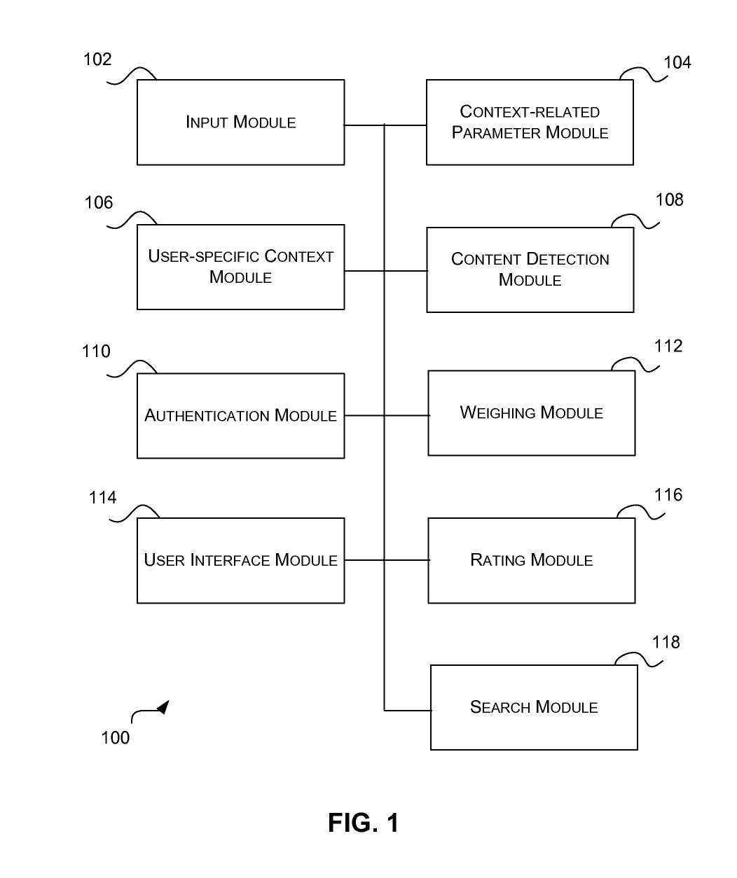

FIG. 1 is a block diagram, illustrating modules that may be used in performing embodiments of the invention. Modules described in reference to FIG. 1 may be implemented in hardware, software, firmware or any combination thereof. Herein, the term “module” refers to structure and does not refer to transitory propagating signals or software per se. In one implementation, the modules described in FIG. 1 are implemented in a mobile device using components similar to the components described in FIG. 10. In another implementation, the modules described in FIG. 1 are implemented in a remote server, also using one or more components from FIG. 10. In yet another implementation, the mobile device and the remote server, collectively implement the modules described with reference to FIG. 1.

Block 102 is the input module, block 104 is the context-related parameter module and block 106 is the user-specific context module. In an exemplary implementation, the input module 102, the context-related parameter module 106 and user-specific context module may operate on one or more remote servers. The input module 102 receives information from various sensors and computing technologies present on the mobile device, via wireless communication, wired communication or any combination thereof. The context-related parameters module 104 receives information from the input module and derives context-related parameters. The user-specific context module 106 receives one or more context-related parameters and derives the user-specific context.

In an example scenario, a group of users are playing billiards at a restaurant. The input module 102 may receive sensor information such as location information (e.g., pseudo ranges, coordinates, or the like) for various mobile devices for the users playing. The context-related parameter module 104 may use the sensor information from the input module 102 to generate context-related parameters. For instance, the context-related parameter module may use the location information from each mobile device to generate a first context-related parameter for each mobile device that is the location of the device. For example, the location information from the input module 102 may refer to location coordinates, whereas the location may refer to an actual establishment, such as a restaurant. In addition, the context-related parameter module may generate a second context-related parameter for expressing the relative positioning of the mobile device with respect to other mobile devices in the vicinity, using the location information. Next, the user-specific context module 106 uses the location of the mobile device, such as the restaurant with a billiards table, and the relative positioning of the users of the mobile devices, such as movement within a rectangular area, to determine that the group of mobile device users are playing billiards at the restaurant.

As discussed in the above example, the input module 102 receives input from various sensors and computing technologies present on the mobile device. For instance, the input module 102 may receive location information, such as coordinates from a GPS module, location tag (e.g., QR code, RFID tag), address, IP address, access point information, signal strength information, camera data, inertial sensors information, etc. Other information useful in deriving the user-specific context may also be received at the input module 102, and may include but is not limited by, ambiance information, lighting conditions, images or video clips from the mobile device camera, noise level in the vicinity of the mobile device, audio level of the mobile device, time of day information, and display information including pointer/mouse information, scroll information, and zoom level information.

The context-related parameter module 104, may obtain, receive, access or derive one or more context-related parameters using information received from the input module 102. Examples of context-related parameters include, but are not limited to, determining the frequency of visits to a location being reviewed, detecting time spent by a user reviewing the content, determining time of the day at which the content is reviewed, determining completeness of the review of the content, determining consumability of the content that is being reviewed, determining user's past behavior while reviewing similar content, detecting user's eye gaze to determine if the user was viewing the content, determining if the device is properly oriented towards the user for viewing of the content, determining location of the user, determining relation between the content and the reviewer and determining the specificity of the review.

The user-specific context module 106 derives a user-specific context based on the context-related parameters received from the context-related parameter module 104. In one embodiment, the user's engagement in a specific activity such as playing billiards or reviewing an online article may be considered a user-specific context. For instance, in one embodiment, the user-specific context determination module receives the location of the device and the relative positioning of the device with respect to other devices and infers that the user of the device is engaged in a game of billiards. In the above described scenario, the user playing billiards is the user-specific context.

At block 108, content detection module detects the content that is the target for being reviewed by the user. In one embodiment, the content detection module 108 may also use the user-specific context in determining the content to be reviewed. For example, in the above example, the user-specific context may be playing billiards at a specific restaurant. Based on the user-specific context, the content detection module 108 may determine that the content to be reviewed may be the restaurant itself or playing billiards at the restaurant. In an alternate embodiment, where a user is reviewing a media clip, such as an audio or video clip or an article on the mobile device, the content detection module 108 may determine that the content to be reviewed is the media clip or the article or a portion of the media clip or the article.

At block 110, authentication module receives the user-specific context from the user-specific context module 106 and the content that the user will review from the content determination module 108. The authentication module 110 authenticates that the user-specific context is the proper context for submitting the review for the content. In some instances, authentication may refer to verifying that the user is performing or has performed the task, or has the appropriate level of exposure to the content for the purposes of reviewing the content.

At block 112, weighing module may weigh the review for the content based on one or more context-related parameters, user-specific context and the content. For instance, when the user reviews an article, the weighing module may take into consideration other user-specific contextual information such as the lighting conditions around the mobile device while the user was reading the article, the user's familiarity with the materials, the portion of the article the user read, etc., in determining the weight to assign to the review and rating. If the surroundings were bright when the user was reading the article, making the display difficult to read, such as direct sunlight on the display, it is likely that the user did not pay close attention to the details in the article and therefore, the weighing module 110 may assign less weight to the review and rating by the user.

At block 114, user interface module provides the user with a user interface for generating and submitting the review. In one embodiment, the user interface module provides the user with the user interface only after the authentication module 110 authenticates that the user-specific context is the proper context for providing a review for the content.

In one embodiment, at block 116, the rating module may be implemented as a separate module than the weighing module 112 and may use information from the weighing module 112 to normalize the rating from the user with respect to other ratings. In another embodiment, the rating module 116 may maintain the rating for content from each user separately from the weight associated with the rating of the content. The rating information associated with the content by the user and the weight associated with the content for the user may be used collectively or separately by a search module 118.

The search module 118 responds to search requests submitted by a user. In one instance, the search module may incorporate the rating of the review in retrieving and organizing the search results for a particular query. For instance, if the user submits a query requesting the best billiards tables in a particular location or the best techniques for saving batter power on mobile devices, the (normalized) reviews and ratings from various users may be factored into the search results produced by the search module 118.

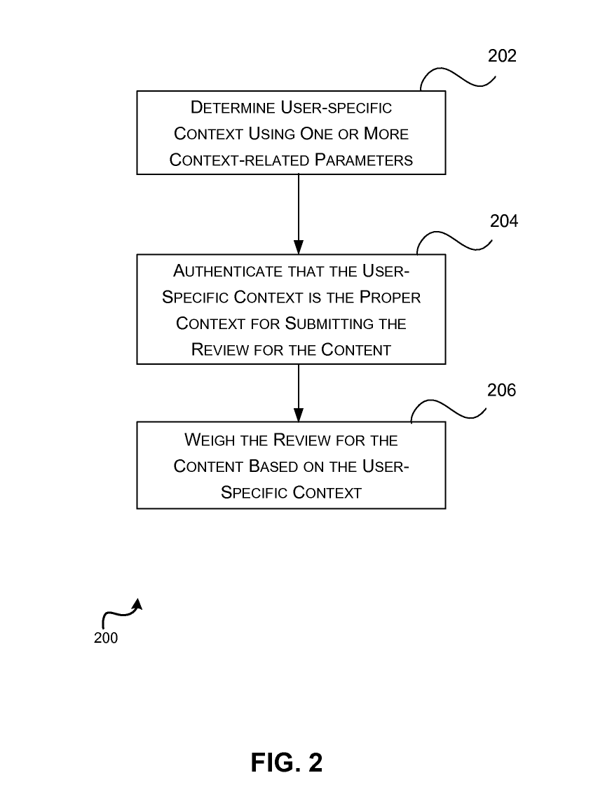

FIG. 2 is a simplified flow diagram, illustrating a method 200 for performing one embodiment of the invention. The method may be performed at the mobile device or at one or more servers on the network or some combination thereof. The method 200 is performed by processing logic that comprises hardware (circuitry, dedicated logic, etc.), software (such as is run on a general purpose computing system or a dedicated machine), firmware (embedded software), or any combination thereof. In one embodiment, the method 200 is performed by system 100 of FIG. 1, such as a remote server or/and the mobile device.

Referring to FIGS. 1 and 2, at Step 202, components of the computer system, such as the user-specific context module 106, may determine the user-specific context using one or more context-related parameters. Examples of user-specific context may include a user playing billiards at a restaurant or user reading an online article at noon in the garden on a sunny day. The user-specific context module 106 may use information from other modules of the review system, such as the input module 102, and context-related parameter module 104, in determining the user-specific context. For example, as described in detail in FIG. 1, the user-specific context module 106 may receive context-related parameters, such as the location of a mobile device (e.g., restaurant) and the relative positioning of multiple mobile devices with respect to other devices, from the context-related parameters module, and determine that the user is playing billiards at the restaurant.

At Step 204, the authentication module 110 authenticates that the user-specific context is the proper context for submitting the review for the content. In one implementation, components of system 100, such as the authentication module 110 may use the user-specific context from the user-specific context module 106 and the content from the content detection module 108 in determining if the review is authentic. In one embodiment, the determination of the authenticity of the review is made before providing the user with the user-interface for entering and submitting the review and rating. This determination may be made on the mobile device or on a remote server. Once the user-specific context is authenticated for being the proper context for reviewing the content, the user may be automatically presented with the option of entering and submitting the review and rating for the content. In another implementation, the authentication module may allow submission of the review, however, discard the review, significantly lower the weight associated with the review (as discussed below in 206), or perform other steps on determining that the review is not authentic.

At Step 206, the review may be optionally weighed to appropriately gauge and account for the reliability of the review. For instance, the weighing module 112 may weigh each collected review to counteract or compensate for possible bias or possible error detected. For example, if the review system 100 receives a review for a portion of an article, embodiments of the invention would weigh the review based on factors such as the lighting conditions while the user was reading the article, the source of the article, how the article got forwarded to the user, the reading speed of the user, if the user scrolled through the whole article or only portion of the article, etc. In some implementation, the weighing module 112 may be used in conjunction with the authentication module 110 or instead of the authentication module.

It should be appreciated that the specific steps illustrated in FIG. 2 provide a particular method of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination there between. Moreover, the individual steps illustrated in FIG. 2 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the method 200.

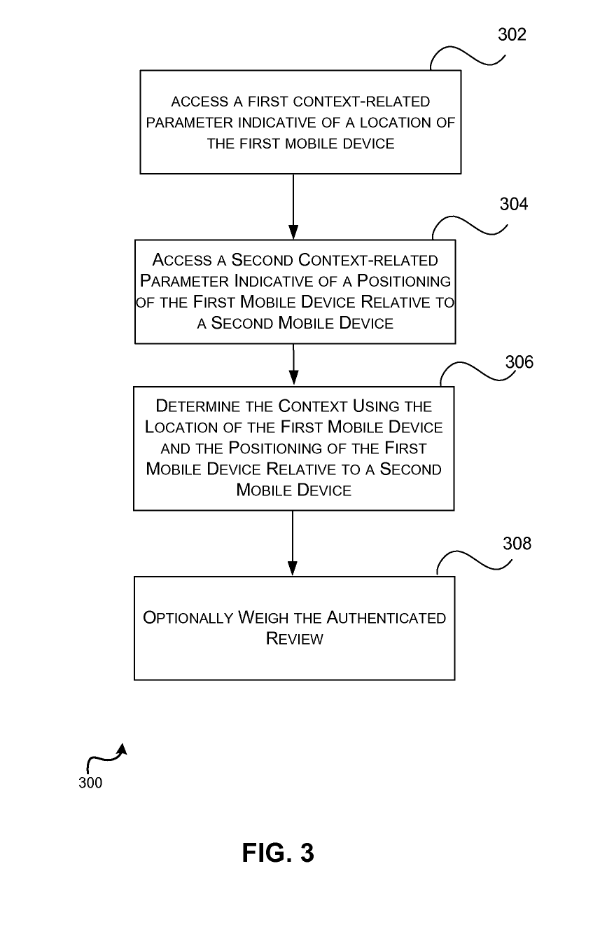

FIG. 3 is another simplified flow diagram, illustrating a method 300 for performing one embodiment of the invention. The method may be performed at the mobile device or at one or more servers on the network or some combination thereof. The method 300 is performed by processing logic that comprises hardware (circuitry, dedicated logic, etc.), software (such as is run on a general purpose computing system or a dedicated machine), firmware (embedded software), or any combination thereof. In one embodiment, the method 300 is performed by system 100 of FIG. 1, such as a remote server or/and the mobile device.

At Step 302, components of system 100, such as the user-specific context module 106, may access a first context-related parameter indicative of a location of the first mobile device. Location may be derived using information indicative of the location, such coordinates from a GPS module, location tag (e.g., QR code, RFID tag), address, IP address, access point information, signal strength, camera, inertial sensors, etc.

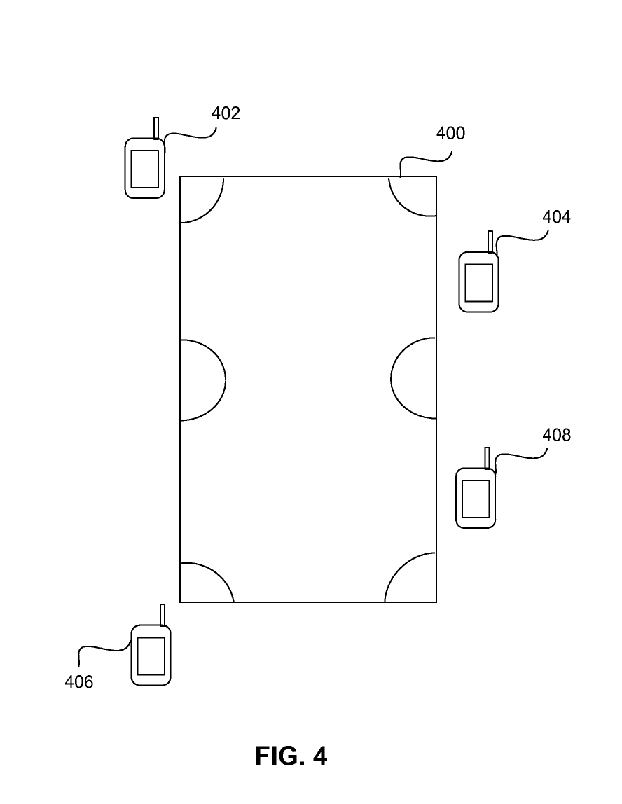

For example, as shown in FIG. 4, a group of four friends may go for a night out at a restaurant or a night club that has a billiards table. The input module 102 may receive location information for the mobile device, such as the location tag information, location coordinates, etc. The context-related parameters module 104 may determine the location based on the location information and determine that the user is at a particular restaurant. The context-related parameters module 104 may also determine finer grain location details such as the location of the mobile device within a particular area of the restaurant or the night club.

At Step 304, components of system 100, such as the user-specific context module 106, may access a second context-related parameter indicative of a positioning of the first mobile device relative to a second mobile device. The context-related parameter module 106 may determine the positioning of the first device with respect to a second mobile device. The determination may be made by calculating the relative positioning of the devices with respect to each other. In one implementation, the relative positioning of the devices with respect to each other is determined locally on the device. The mobile devices may communicate directly with each other using wireless means such as WiFi, Bluetooth, etc. In another implementation, the mobile devices may send their location information to a remote server for calculating the relative positioning between the various devices.

In the example illustrated by FIG. 4, context-related parameter module 106 may determine the positioning of the first device, as discussed in step 304, such as device 402 from FIG. 4 with respect to other devices (e.g., 404, 406, 408) by calculating the distance between the first mobile device and the mobile devices in the vicinity or part of a pre-determined group.

At step 306, components of system 100, such as the user-specific context module 106, determines the context using the location of the first mobile device and the positioning of the first mobile device relative to a second mobile device. In one embodiment, the user-specific context may comprise an activity performed by the user, such as playing billiards, sitting in a movie theater watching a movie, or standing in a queue at a coffee shop to order a coffee. In the example illustrated by FIG. 4, components of system 100 determine that the user is at a location, such as a restaurant or a night club that has billiards tables. The method, as performed by components of system 100, further analyzes the positioning of the various mobile devices with respect to each other. In one scenario, the method determines that the configuration of the first device with the second device or other devices forms a pattern that is indicative of the users of the mobile devices playing billiards at the establishment.

In one implementation, the method performed by components of system 100 may automatically provide a user interface to the user for entering and submitting a review for the location, such as the restaurant or the night club for playing billiards, in response to determining that the user is engaged in a game of billiards at the establishment. In another implementation, components of system 100, such as the authentication module 110, may allow submission of the review, however, discard the review, significantly lower the weight associated with the review (as discussed in Step 206), or perform other steps on determining that the review is not authentic.

In one embodiment, at Step 308, the review entered and submitted by the user for the content may be further weighed, by the weighing module 112 of the review system 100, based on the user-specific context and the content of the review. For instance, if the user is a regular billiards player and has played at many establishments and has published reviews for many places, the user's reviews may be given more weightage by the weighing module 112 than a user who seldom plays billiards. In one implementation, the weighing module 112 may be implemented instead of the authentication module and the bias in the reviews may be normalized over a large sample of reviews by weighing each review instead of explicit authentication of each review context.

It should be appreciated that the specific steps illustrated in FIG. 3 provide a particular method of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination there between. Moreover, the individual steps illustrated in FIG. 3 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the method 300.

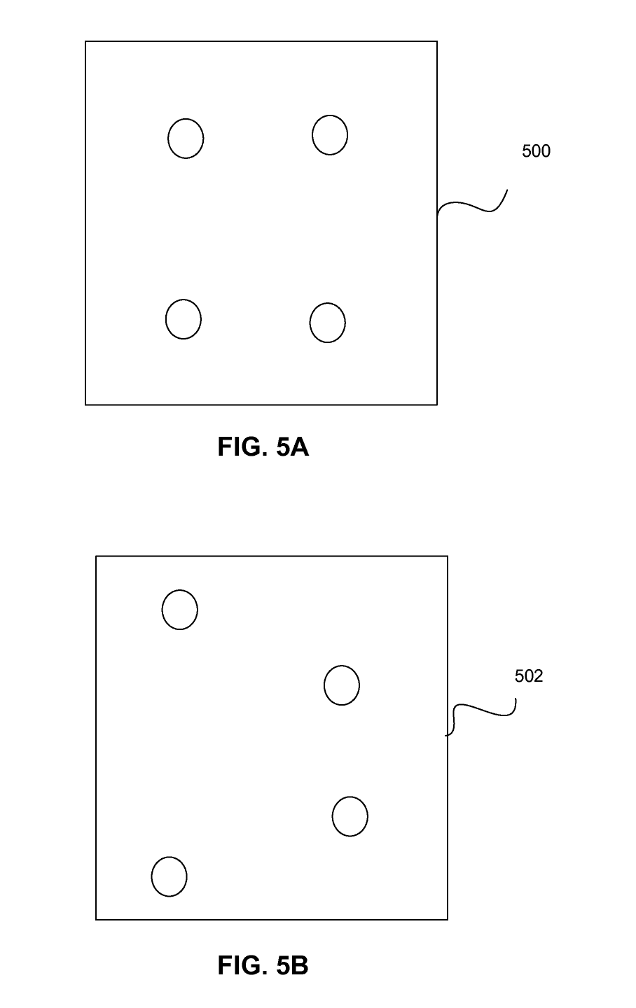

In one implementation, components of system 100, such as the authentication module 110, may provide the user interface to the user for entering the review and submitting it after the completion of the activity performed at the establishment, such as playing billiards, drinking at the bar, dining or dancing on the dance floor. Embodiments of the invention may use different techniques for determining that the activity is completed. FIGS. 5A and 5B illustrates one implementation, where an artificial threshold boundary may be established around the users playing billiards by the review system. For instance, the threshold may allow the users of the mobile device to move about in the area indicated by the boundary, such as 500 and 502 in FIGS. 5A and 5B, respectively, without triggering a completion of the activity. For instance, FIG. 5A shows that the users of the mobile devices are in a first configuration, whereas FIG. 5B shows that the users of the mobile devices are in second configuration and are further dispersed in the area than in the first configuration. Since, during the billiards game people may move around, exchange places and move further away or come closer to the billiards table, embodiments of the invention may not flag the completion of the activity as long as the user stays within the boundary.

In addition, in some implementations, embodiments of the invention may use a time threshold that allows the mobile devices belonging to the group (playing billiards in the above example) to temporarily leave and reenter the boundary or distance threshold without indicating a completion of the activity. For instance, some of the players at the billiards table may leave temporarily to use the washroom or get a drink from the bar.

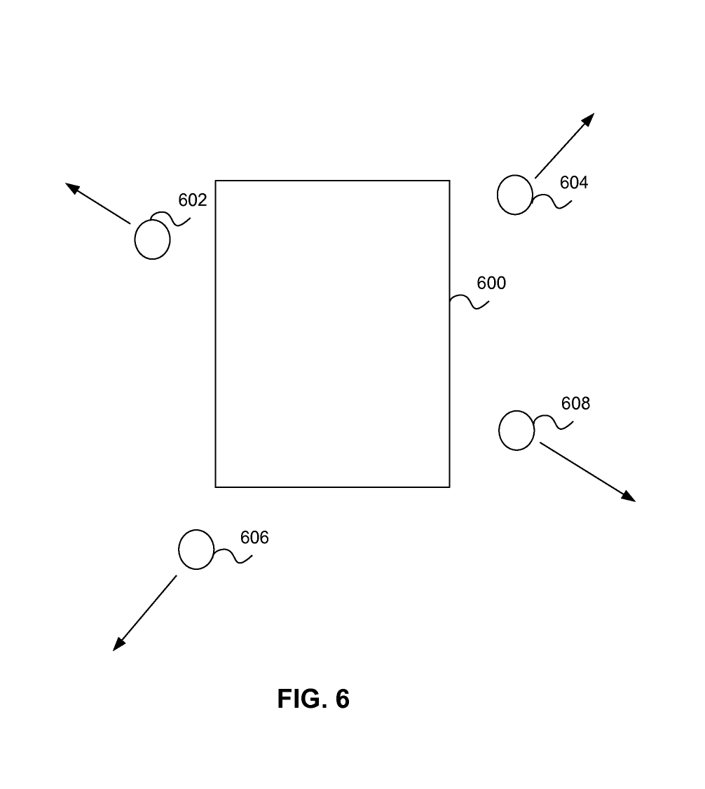

FIG. 6 is a figure illustrating an example setting where the review system detects a completion of the activity. In one aspect, activity may include an altered positioning of one mobile device relative to another mobile device. And the completion of the activity may comprise detecting an increase in the distance in the relative position of the first mobile device with respect to the second mobile device beyond a boundary or a distance threshold. As shown in FIG. 6, as the users of the mobile devices are done playing billiards, the users with the mobile devices 602, 604, 606, and 608 leave and move outside the boundary 600 moving away from the billiards table and each other. The mobile device or the server calculates the dispersion of the devices with respect to each other. Since embodiments of the invention detect that the mobile devices are moving away from the billiards table and are outside the boundary, embodiments of the invention may determine that the users are done playing billiards and the activity is completed. In one embodiment, the users are automatically presented with a user interface on their mobile device for entering and submitting the review, in response to detecting that the billiards game is over.

In some embodiments, the authenticated review may be further weighed using user-specific contextual information. For instance, weighing the review may include associating a higher weight with a group review than a non-group review. The group review may be a review generated by the mobile device associated with a group activity. The group activity may include associating a mobile device with a group of mobile devices participating in the same activity as a group. In the above example of FIGS. 4, 5A, 5B and 6, the four friends playing billiards are engaged in a group activity. Once the friends have completed playing billiards, their mobile device may automatically provide an interface for entering and submitting reviews. If the activity is tagged as a group activity, the reviews associated with the group activity may be given higher weightage. The review system may associate higher weight with the group activity, since it may provide more points of authentication using information from each mobile device, providing further assurance of the authenticity of the review. Furthermore, the review system may determine that the activity group is a known group by using social networking information or previously formed associations between the mobile devices. The reputation of a known group may also become a determining factor in weighing and rating the reviews. For example, the group of players reviewing the content may belong to a professional league (circle/group in a social network) of billiard players.

Similar bias in reviewing content may also be evident while reviewing media content such as articles, papers, audio and video clips. Social networks facilitate fast dissemination of content throughout the internet. However, such means of disseminating information based on referrals leads to a biased rating, for e.g. an article when forwarded to friends, may get higher “thumbs up” from friends and relatives. This may be true even in scenarios where the receiver of the forwarded article may have not read the article or viewed the content even partially. This is also true for “thumbs down” rating as well. A person may have a prejudiced opinion towards an individual that the content is associated with, which may result in “thumbs down” without proper consideration. In some embodiments, the content maybe reviewed using a mobile device.

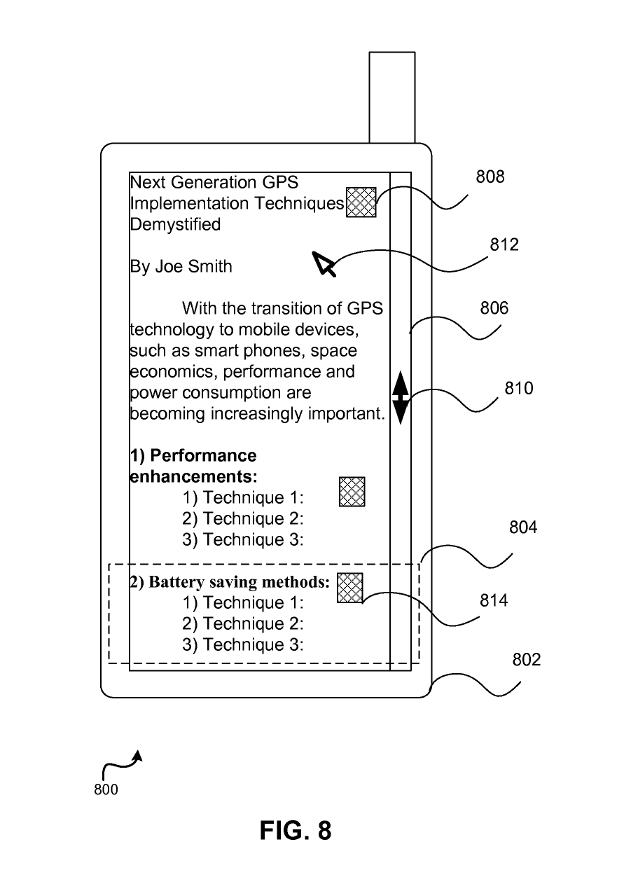

Moreover, when a user is looking for articles based on their highest rated on a particular topic, for example, “battery saving methods,” a search may pull up articles based on the ratings for battery saving methods. However, if there is a mediocre article about GPS, as shown in FIG. 8, that may have interesting findings about power savings, and if the article is rated over all low, the article has less chance of showing up in the search. In embodiments of the invention, a method performing embodiments of the invention could validate the user's ratings for different content and also provide a way to tag and review sub-sections of the content. Furthermore, the review system 100 may auto-generate the user-interface for the content for the user to review when the user highlights a particular section of the article.

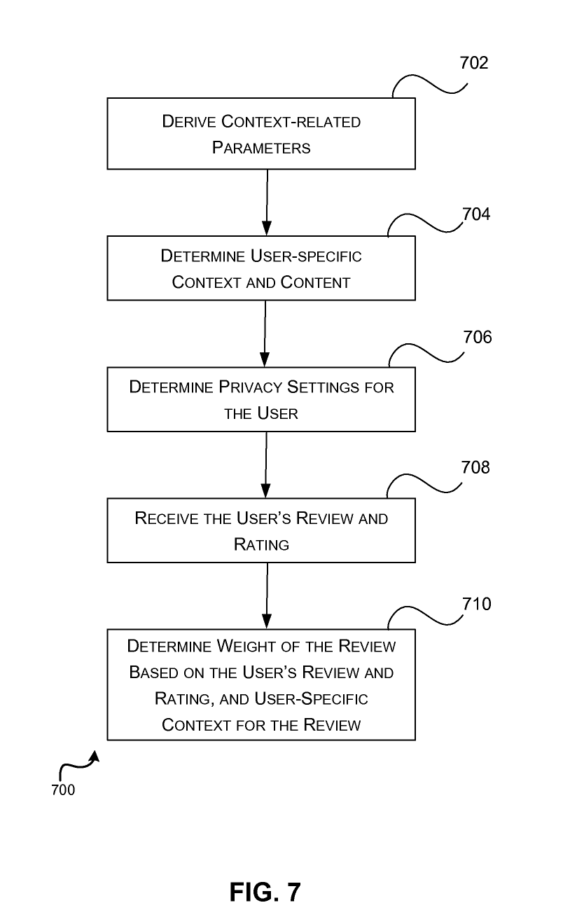

FIG. 7 is a simplified flow diagram, illustrating a method 700 for performing one embodiment of the invention. The method may be performed at the mobile device or at one or more servers on the network or some combination thereof. The method 700 is performed by processing logic that comprises hardware (circuitry, dedicated logic, etc.), software (such as is run on a general purpose computing system or a dedicated machine), firmware (embedded software), or any combination thereof. In one embodiment, the method 700 is performed by system 100 of FIG. 1, such as a remote server or/and the mobile device.

As discussed earlier, the input module 102 of the review system 100 receives input from various sources, such as the mobile device and remote databases. Input may include data from the mobile device, such as LCD touch screen, key pad sensor, microphone, speaker, camera, Bluetooth or WiFi controller. At Step 702, the context-related parameter module 104 may obtain, receive, access or derive one or more context-related parameters using information received from the input module 102. Examples of context-related parameters may include, but are not limited to, determining the frequency of visits to a location being reviewed, detecting time spent by a user reviewing the content, determining time of the day at which the content is reviewed, determining completeness of the review of the content, determining consumability of the content that is being reviewed, determining user's past behavior while reviewing similar content, detecting user's eye gaze to determine if the user was viewing the content, determining if the device is properly oriented towards the user for viewing of the content, determining location of the user, determining relation between the content and the reviewer, and determining the specificity of the review.

At Step 704, the review system determines the user-specific context. The user specific context may be the environment in which the user reviews the content. One example of user-specific context may be a user reading an article online during the day with the sun shining right on the display of the device, causing the display to be very difficult to read. This example user-specific context may be derived by the user-specific context module 108 using context-related parameters, such as determining time of the day at which the content is reviewed, determining location of the user, determining the activity the user is engaged in while reviewing the content, and determining the lighting conditions. In addition to the user-specific context, the content being reviewed may also be determined. In this example scenario, the content determination module 108 may determine that the user is reading the highlights of an article in the sports section of the New York Times online.

At Step 706, the review system 100 may load the user-specific details of the account, such as privacy settings, before using user-specific details in weighing the review and rating. The user-specific settings may be received from the user's mobile device or stored at a remote database. In one scenario, the user may opt out of using information about the user in weighing the review. In such a scenario, the review system 100 may either not publish or use the user's review or may weigh the review low relative to other reviews.

At Step 708, components of the review system 100, such as the user interface module 114 may provide a user interface for entering and submitting a review for the content. In one embodiment, the user-interface may be automatically provided once the user has completed reviewing the content. Alternatively, the user-interface module 114 may provide a button or review indicator placed in various sections or the content, such as an article, for the user to manually invoke a user-interface. Other suitable methods of invoking the user-interface, both automatic and manual, may be used in embodiments of the invention.

At Step 710, the review system 100 may weigh the review from the user, based on the user-specific context and content. One implementation for weighing the reviews and ratings from the user is described below. For example, W1, W2 . . . WN are the weights for the number of users—N1, N2 . . . Nn—where behavior may match any of the above mentioned states.

Total Weightage (W) may be calculated as:

W=(W1*N1+W2*N2+ . . . +Wn*Nn)/N,

where W1, W2, . . . Wn, are weightage for the above states,

where N1, N2, . . . Nn are number of users in one of the above mentioned states, and

where N=total number of users and N1, N2, . . . Nn<N

This example method may be applied by the review system in addition to the direct ratings given by the users for the content. The above rating method described is an example of the different methods that may be implemented in the weightage module. An additional method may be applied as follows:

Weightage per reviewer=W/T,

where W is the number of attributes that met the conditions and T is the total attributes supported in the device.

It should be appreciated that the specific steps illustrated in FIG. 7 provide a particular method of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination there between. Moreover, the individual steps illustrated in FIG. 7 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the method 700.

FIG. 8 illustrates an example mobile device 802 that may enable embodiments of the invention. The mobile device may be implemented using one or more components described in FIG. 10. The mobile device may have a display touch screen 806. As shown in an example scenario, an online article may be displayed on the display device 806. The online article may be associated with a particular publisher, newspaper and author. In addition, the online article may have several section headings discussing various discrete topics. The example article in FIG. 8 is an article titled “Next Generation GPS Implementation Techniques Demystified,” with several sub-sections that are visible in FIG. 8 and include “performance enhancements” and “Battery saving methods.” The article may also include other sub-sections with section headings that are not visible on the display screen, but may be accessed by scrolling the scroll bar 810 or moving the pointer 812.

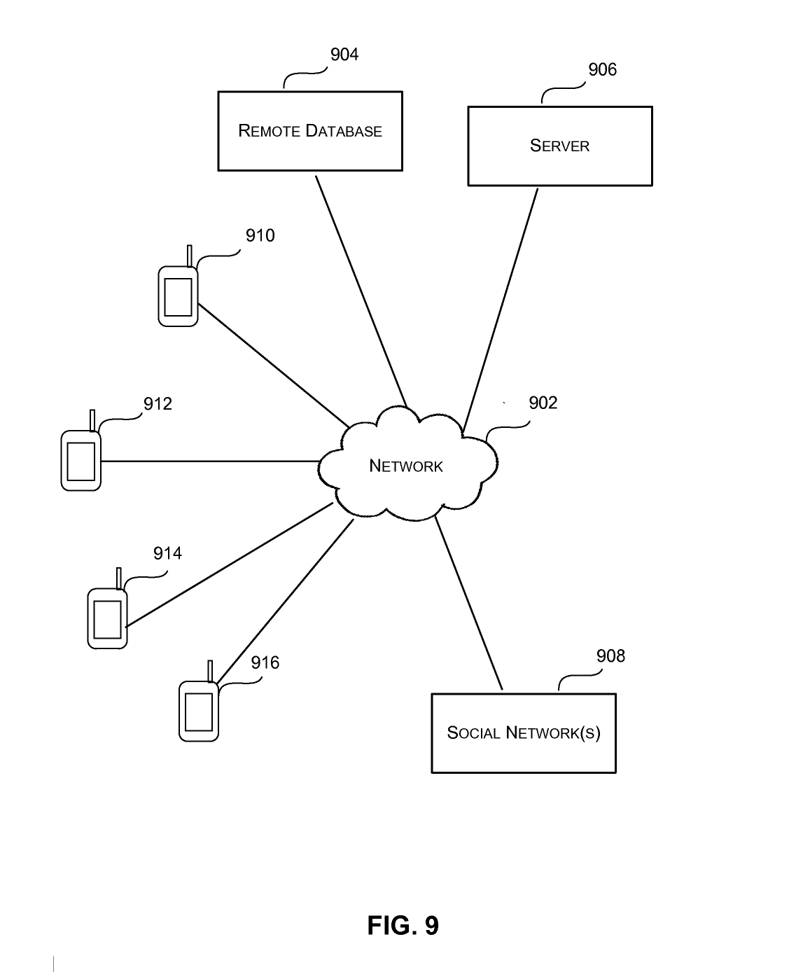

In one implementation, the components of the review system 100 described may be implemented on one or more remote servers in the network, as part of the cloud, as further discussed in FIG. 9. The remote server may be implemented using one or more components discussed in FIG. 10. The remote server may receive sensor and other input from the mobile device 802 using the input module 102. In another implementation, some or all of the components of the review system 100 described in FIG. 1, may be implemented on the mobile device 802.

As discussed earlier, the mobile device 802, may facilitate the review of content by temporally relaying (to a remote server or internal components of the mobile device 802) sensor information that may be used to derive the user-specific context. In one embodiment, the mobile device 802, may facilitate review of the content by association with the user's location, position, orientation and activity. In other embodiments, the mobile device 802 participates in exposing the user to the content, such as a media clip or an article, as shown in FIG. 8.

In some embodiments, the review system 100 may allow reviewing of a sub-portion of the content (i.e., for a partial content within the entire content) where the content may be a media clip, such as text, audio or video or combination thereof

For example, in FIG. 8, the reviewer may read the article about “GPS implementation techniques” and may only like the section about “Battery savings methods” while using GPS, indicated by block 804 in FIG. 8, and dis-likes the rest of the article. In such a scenario, the review system 100 may provide the reviewer with an interface to provide a rating about the particular point/context mentioned in the article. In an example implementation, the user may be able to highlight a sentence with a particular phrase and the review system 100 may derive a tag or context associated with the phrase and allow the user to rate that specific point/context mentioned in the article. For example, in the article displayed in FIG. 8, the review system 100 may allow the user to review the section with the heading “battery saving methods.” In another implementation, the user-interface 114 for the review system 100 may provide indicators for the whole article (808) and sub-portions (814) of the article that the user may manipulate for invoking the user-interface for providing the review.

When the search module 118 receives input from a user for battery saving techniques, the search module 118 may return with hits on this particular article with the battery saving techniques highlighted in the article if that section had a high enough ratings for that particular point and context.

Similar techniques may be applicable for image content as well, where the reviewer may be able to review a sub-portion of the image within a full image. For example, if the reviewer can rate Eiffel Tower within an image with multiple persons in the fore ground, the review system 100 can determine that the rating is for Eiffel Tower by comparing the rating against the selection of Eiffel Tower part within the image by the user and searching against its image database and tag the sub-portion accordingly. Additionally, the review system 100 may rely on user's tagging of the Eiffel Tower and may associate the rating and review for Eiffel Tower within its system. Consequently, a search for Eiffel Tower with highest ratings may return the above picture if it gets rated high by multiple users

In the case of other media clips, such as audio or video clips, the review system 100 may allow reviewers to review or rate specific moments and determine the context based on markers, tags or GMPs (Good moment points) inserted within the larger content by the author or other people.

For example, for content of 5 minutes, the reviewer may like to give “thumbs up” to the content between 1st and 2nd minutes, so the review system 100 may tag the context associated with those moments. For example, in an audio clip, the time between the 1st and 2nd minute may have music from a specific instrument, such as a violin that is played. Another example would be a complete football match video with marked touch down moments.

When a search query is received by the search module 118 for touch down moments or violin content, the review system 100 may return the content matching the above conditions and may start playing the content from the time stamp where the user's search matched. For example, if the received search query is about touch down moments and the search matches the moments present in the complete football content, then the touchdown moments may be retrieved and displayed to the user. A complete football match may then have a timeline marked for touch down with highest ratings. When the user clicks the video, instead of playing from the beginning, the user interface 114 may start playing from the moments before or about the touch down was about to happen during the football match.

Following is a table with example contextual information and its significance in weighing the reviews for the content, by the weighing module 112 of the review system 100.

| | Contextual | |
|---|---|---|
| | information | Example significance |
| 1 | Duration for which the | Indicates the time and effort spent by the user in |
| | user viewed the | reviewing the content |
| | content | |
| 2 | Time of viewing | The user may be less alert, late night or early morning |
| 3 | Movement of the | Indicates the sections of the article read by the user. |
| | scroll-bar | |
| 4 | Speed of the scroll | Indicates if the user read the content in detail or just |
| | bar. | skimmed over the materials |
| 5 | Zoom level | Indicates whether the text is properly visible to the user at |
| | | the current zoom level to provide a thorough review |
| 6 | Audio volume | Indicates whether the audio level is too low or muted |
| | | while the user was apparently reviewing the content. |
| 7 | Headphone | Was the headphone connected, but not worn by the user |
| | | while reviewing the content? |
| 8 | Display screen | Was the display screen on while reading the article or |
| | | watching the video? |
| 9 | Constant pauses while | May indicate that the user is distracted |
| | reviewing the media | |
| | clip | |
| 10 | Other activities on the | May indicate that the user is distracted with other |
| | device while the user | activities on the device and running the content in the |
| | is reviewing the | background. |
| | content | |
| 11 | Users past reading | If the user can read 100 words a minute on average and |
| | behavior | article is about 500 words and if the user has completed |
| | | reading the article in less than 1 minute, then it may be |
| | | inferred that the user did not review the article in its |
| | | entirety |
| 12 | User's eye gaze | Indicates whether the user was viewing the article or |
| | | video |
| 13 | Grip sensor | Indicates if the device is being held at a position that is |
| | | good for viewing or reading |
| 14 | State of connected | When the device 1 (smart phone) is connected with other |
| | device | devices (tablet) on peer-peer network |
| 15 | Location of the user | Indicates whether the user is at home, driving, sitting in a |
| | using GPS, WiFi, etc. | conference room while rating the article |
| 16 | Body status of the user | Sitting, standing, etc. |
| 17 | Ambient conditions | Ambient conditions in the surrounding environment while |
| | | rating the content |
| 18 | Microphone sensor | Noise conditions. Example: Was TV or on while |
| | | watching a video or hearing an audio? |
| 19 | Light conditions | Was it too bright on the LCD screen while watching the |
| | | video content or the reviewer was outside in the sun, |
| | | making it difficult to review the video |
| 20 | Relation between | e.g. 1) If the article is about a land mark, is the re-viewer |
| | article and the | also from that location? |
| | reviewer | 2) If the content is about the product/organization, is there |
| | | any direct relation/connection between the user and the |
| | | company that manufactured the product? |
| | | 3) Is the re-viewer an expert in the field by checking |
| | | his/her social networking status and/or connections? |
| | | 4) Is the re-viewer directly related to author by checking |
| | | his social networking circle? |
| | | 5) Is the reviewer rating prejudiced about the author by |
| | | checking the previous ratings given the reviewer for the |
| | | same author? |
| 21 | Does the user own the | If the article is about a product and the reviewer is rating |
| | product? | the article, does the reviewer own the product? In one |
| | | embodiment, the reviewer may upload the image of the |
| | | device or provide information which could validate if |
| | | he/she is the owner, for example, by scanning the bar code |
| | | of the item |
| 22 | Did the reviewer | More specific details may mean that the reviewer has read |
| | comment about | or viewed the content carefully or has actually visited the |
| | specific details of the | facility/establishment |
| | content in the review? | |
| 23 | Review of a live event | Was the reviewer present in that location using GPS, |
| | | microphone sensor or watching it over TV using |
| | | microphone sensor? |
| 24 | Actions by the user | Did the user do a search about the some specific points |
| | preceding the review | about the content which he/she reviewed? |

FIG. 9 is an oversimplified and example figure, illustrating multiple mobile devices (910, 912, 914 and 916) connected to network resources. Network resources may include, but are not limited to, network connectivity, processing power, storage capacity and the software infrastructure. In some implementations, all or part of the network resource may be referred as a “cloud.” Remote database(s) 904, remote server(s) 906 and social network(s) 908 may exist as part of the network 902 or connected to the network 902 and may be implemented using one or more components discussed in FIG. 10. Social networks may include social connectivity networks and social media networks such as Facebook®, Twitter®, Four-Square®, Google Plus®, etc. The mobile devices may connect to the various network resources through a wireless or wired connection.

FIG. 10 illustrates an example computing device incorporating parts of the device employed in practicing embodiments of the invention. For example, device 1000 can represent some of the components of a mobile device, discussed above. A mobile device may be any computing device with an input sensory unit like a camera and a display unit. Examples of a mobile device include, but are not limited to, video game consoles, tablets, smart phones, camera devices and any other hand-held devices suitable for performing embodiments of the invention. Device 1000 may also represent one or more of the components of remote servers or other entities operating in a network or cloud, such as a remote database or a remote social network. FIG. 10 provides a schematic illustration of one embodiment of a device 1000 that can perform the methods provided by various other embodiments, as described herein. FIG. 10 is meant only to provide a generalized illustration of various components, any or all of which may be utilized as appropriate. FIG. 10, therefore, broadly illustrates how individual system elements may be implemented in a relatively separated or relatively more integrated manner. In one embodiment, only some of the components described in FIG. 10 are implemented and enabled to perform embodiments of the invention. For example, a camera device may have one or more cameras, storage, or processing components along with other components described in FIG. 10.

The device 1000 is shown comprising hardware elements that can be electrically coupled via a bus 1005 (or may otherwise be in communication, as appropriate). The hardware elements may include one or more processors 1010, including without limitation one or more general-purpose processors and/or one or more special-purpose processors (such as digital signal processing chips, graphics acceleration processors, and/or the like); one or more input devices 1015, which can include without limitation a camera, sensors (including inertial sensors), a mouse, a keyboard and/or the like and one or more output devices 1020, which can include without limitation a display unit, a printer and/or the like. In addition, hardware elements may also include one or more sensors 1050, as shown in FIG. 10, for acquiring sensor input.

The device 1000 may further include (and/or be in communication with) one or more non-transitory storage devices 1025, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including, without limitation, various file systems, database structures, and/or the like.

The device 1000 might also include a communications subsystem 1030, which can include without limitation a modem, a network card (wireless or wired), an infrared communication device, a wireless communication device and/or chipset (such as a Bluetooth™ device, an 802.11 device, a WiFi device, a WiMax device, cellular communication facilities, etc.), and/or the like. The communications subsystem 1030 may permit data to be exchanged with a network (such as the network described below, to name one example), other devices, and/or any other devices described herein. In many embodiments, the device 1000 will further comprise a non-transitory working memory 1035, which can include a RAM or ROM device, as described above.

The device 1000 also can comprise software elements, shown as being currently located within the working memory 1035, including an operating system 1040, device drivers, executable libraries, and/or other code, such as one or more application programs 1045, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 1025 described above. In some cases, the storage medium might be incorporated within a device, such as device 1000. In other embodiments, the storage medium might be separate from a device (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the device 1000 and/or might take the form of source and/or installable code, which, upon compilation and/or installation on the device 1000 (e.g., using any of a variety of generally available compilers, installation programs, compression/decompression utilities, etc.), then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Some embodiments may employ a device (such as the device 1000) to perform methods in accordance with the disclosure. For example, some or all of the procedures of the described methods may be performed by the device 1000 in response to processor 1010 executing one or more sequences of one or more instructions (which might be incorporated into the operating system 1040 and/or other code, such as an application program 1045) contained in the working memory 1035. Such instructions may be read into the working memory 1035 from another computer-readable medium, such as one or more of the storage device(s) 1025. Merely by way of example, execution of the sequences of instructions contained in the working memory 1035 might cause the processor(s) 1010 to perform one or more procedures of the methods described herein.

The terms “machine-readable medium” and “computer-readable medium,” as used herein, may refer to any article of manufacture or medium that participates in providing data that causes a machine to operate in a specific fashion. In an embodiment implemented using the device 1000, various computer-readable media might be involved in providing instructions/code to processor(s) 1010 for execution and/or might be used to store and/or carry such instructions/code (e.g., as signals). In many implementations, a computer-readable medium is a physical and/or tangible storage medium. Such a medium may take many forms, including, but not limited to, non-volatile media, volatile media, and transmission media. Non-volatile media include, for example, optical and/or magnetic disks, such as the storage device(s) 1025. Volatile media include, without limitation, dynamic memory, such as the working memory 1035. “Computer readable medium,” “storage medium,” and other terms used herein do not refer to transitory propagating signals. Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, or any other memory chip or cartridge.

Various forms of computer-readable media may be involved in carrying one or more sequences of one or more instructions to the processor(s) 1010 for execution. Merely by way of example, the instructions may initially be carried on a magnetic disk and/or optical disc of a remote computer.

The communications subsystem 1030 (and/or components thereof) generally will receive the signals, and the bus 1005 then might carry the signals (and/or the data, instructions, etc. carried by the signals) to the working memory 1035, from which the processor(s) 1010 retrieves and executes the instructions. The instructions received by the working memory 1035 may optionally be stored on a non-transitory storage device 1025 either before or after execution by the processor(s) 1010.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

What is claimed is:

1. A method for authenticating a user-specific context in a process to submit a review for content, the method comprising:
determining the user-specific context using one or more context-related parameters; and
authenticating that the user-specific context is a proper context for submitting the review for the content.

2. The method of claim 1, wherein the one or more context-related parameters comprise at least a first context-related parameter indicative of a location of a first mobile device and a second context-related parameter indicative of a positioning of the first mobile device relative to a second mobile device, and wherein determining the user-specific context using the one or more context-related parameters comprises:
accessing the first context-related parameter indicative of the location of the first mobile device;
accessing the second context-related parameter indicative of a positioning of the first mobile device relative to the second mobile device; and
determining the user-specific context using the location of the first mobile device and the positioning of the first mobile device relative to the second mobile device.

3. The method of claim 2, wherein the location is from a group consisting of location address, location name, location tag, location coordinates, and contextual information indicative of the location.

4. The method of claim 1, wherein the content is from a group consisting of a location, a social gathering, a business, an activity at the business, an event, a local attraction, an article or a portion of the article, and a media clip or a portion of the media clip.

5. The method of claim 1, wherein authenticating the review for the content comprises determining that a user performed an activity associated with the review, wherein determining that the user performed the activity is based on the context-related parameters.

6. The method of claim 1, wherein authenticating the review for the content comprises determining that a user completed an activity associated with the review, wherein determining that the user completed the activity is based on the context-related parameters.

7. The method of claim 6, wherein the activity comprises an altered positioning of a first mobile device relative to a second mobile device and wherein detecting completion of the activity comprises detecting an increase in distance in relative position of the first mobile device with respect to the second mobile device beyond a distance threshold.

8. The method of claim 7, wherein completion of the activity further comprises detecting the increase in the distance beyond the distance threshold for a time period beyond a time threshold.

9. The method of claim 1, further comprising authenticating the user-specific context prior to generating a user interface to submit the review for the content.

10. The method of claim 1, further comprising generating a user interface to submit the review for the content, and initiating an unauthenticated review process if the user-specific context is not authenticated.

11. The method of claim 1, further comprising weighing the review for the content based on the user-specific context.

12. The method of claim 11, wherein the weighing the review comprises associating a higher weight with a group review than a non-group review, wherein the group review is the review generated by a first mobile device associated with a group activity.

13. The method of claim 12, wherein the group activity comprises associating the first mobile device with a group of mobile devices participating in the same activity as a group.

14. The method of claim 12, further comprising determining if a group performing the group activity is a known group by using social networking information or previously formed associations between the first mobile device and other mobile devices from the group and weighing the review for the group review based on information associated with the known group.

15. The method of claim 11, wherein weighing the review for the content based on the user-specific context of the review comprises:
determining reliability of the review for the content based on the user-specific context of the review; and
weighing the review based on the determined reliability of the review.

16. The method of claim 1, wherein the context-related parameter is selected from a group comprising determining frequency of visits to a location being reviewed, detecting time spent by a user reviewing the content, determining time of day at which the content is reviewed, determining completeness of the review of the content, determining consumability of the content that is being reviewed, determining user's past behavior while reviewing similar content, detecting eye gaze of the user to determine if the user was viewing the content, determining if a device is properly oriented towards the user for viewing of the content, determining location of the user, determining activity the user is engaged in while reviewing the content, determining relation between the content and reviewer, and determining specificity of the review.

17. A server, comprising one or more processors configured to:
determine a user-specific context using one or more context-related parameters; and
authenticate that the user-specific context is a proper context for submitting a review for content.

18. The server of claim 17, wherein the one or more context-related parameters comprise at least a first context-related parameter indicative of a location of a first mobile device and a second context-related parameter indicative of a positioning of the first mobile device relative to a second mobile device, and wherein the one or more processors are further configured to:
access the first context-related parameter indicative of the location of the first mobile device;
access the second context-related parameter indicative of a positioning of the first mobile device relative to the second mobile device; and
determine the user-specific context using the location of the first mobile device and the positioning of the first mobile device relative to the second mobile device.

19. The server of claim 18, wherein the location is from a group consisting of location address, location name, location tag, location coordinates, and contextual information indicative of the location.

20. The server of claim 17, wherein the content is from a group consisting of a location, a social gathering, a business, an activity at the business, an event, a local attraction, an article or a portion of the article, and a media clip or a portion of the media clip.

21. The server of claim 17, wherein authenticating the review for the content comprises determining, by the one or more processors, that a user performed an activity associated with the review, wherein determining that the user performed the activity is based on the context-related parameters.

22. The server of claim 17, wherein authenticating the review for the content comprises determining, by the one or more processors, that a user completed an activity associated with the review, wherein determining that the user completed the activity is based on the context-related parameters.

23. The server of claim 22, wherein the activity comprises an altered positioning of a first mobile device relative to a second mobile device and wherein detecting completion of the activity comprises detecting, by the one or more processors, an increase in distance in relative position of the first mobile device with respect to the second mobile device beyond a distance threshold.

24. The server of claim 23, wherein completion of the activity further comprises detecting, by the one or more processors, the increase in the distance beyond the distance threshold for a time period beyond a time threshold.

25. The server of claim 17, wherein the one or more processors are further configured to authenticate the user-specific context prior to generating a user interface to submit the review for the content.

26. The server of claim 17, wherein the one or more processors are further configured to generate a user interface, by the one or more processors, to submit the review for the content and initiate an unauthenticated review process if the user-specific context is not authenticated.

27. The server of claim 17, wherein the one or more processors are further configured to weight the review for the content based on the user-specific context.

28. The server of claim 27, wherein the weighing the review comprises associating a higher weight with a group review than a non-group review, wherein the group review is the review generated by a first mobile device associated with a group activity.

29. The server of claim 28, wherein the group activity comprises associating, by the one or more processors, the first mobile device with a group of mobile devices participating in the same activity as a group.

30. The server of claim 28, wherein the one or more processors are further configured to determine if a group performing the group activity is a known group by using social networking information or previously formed associations between the first mobile device and other mobile devices from the group and weighing the review for the group review based on information associated with the known group.

31. The server of claim 27, wherein the one or more processors are configured to:
determine reliability of the review for the content based on the user-specific context of the review; and
weigh the review based on the determined reliability of the review.

32. The server of claim 27, wherein the context-related parameter is selected from a group comprising determining frequency of visits to a location being reviewed, detecting time spent by a user reviewing the content, determining time of day at which the content is reviewed, determining completeness of the review of the content, determining consumability of the content that is being reviewed, determining user's past behavior while reviewing similar content, detecting eye gaze of the user to determine if the user was viewing the content, determining if a device is properly oriented towards the user for viewing of the content, determining location of the user, determining activity of the user is engaged in while reviewing the content, determining relation between the content and reviewer, and determining specificity of the review.

33. A non-transitory computer readable storage medium coupled to a processor, wherein the non-transitory computer readable storage medium comprises a computer program executable by the processor comprising:
determining the user-specific context using one or more context-related parameters; and
authenticating that the user-specific context is a proper context for submitting the review for the content.

34. The non-transitory computer readable storage medium of claim 33, wherein the one or more context-related parameters comprise at least a first context-related parameter indicative of a location of a first mobile device and a second context-related parameter indicative of a positioning of the first mobile device relative to a second mobile device, and wherein determining the user-specific context using the one or more context-related parameters comprises:
accessing the first context-related parameter indicative of the location of the first mobile device;
accessing the second context-related parameter indicative of a positioning of the first mobile device relative to the second mobile device; and
determining the user-specific context using the location of the first mobile device and the positioning of the first mobile device relative to the second mobile device.

35. The non-transitory computer readable storage medium of claim 34, wherein the location is from a group consisting of location address, location name, location tag, location coordinates, and contextual information indicative of the location.

36. The non-transitory computer readable storage medium of claim 33, wherein the content is from a group consisting of a location, a social gathering, a business, an activity at the business, an event, a local attraction, an article or a portion of the article, and a media clip or a portion of the media clip.

37. The non-transitory computer readable storage medium of claim 33, wherein authenticating the review for the content comprises determining that a user performed an activity associated with the review, wherein determining that the user performed the activity is based on the context-related parameters.

38. The non-transitory computer readable storage medium of claim 33, wherein authenticating the review for the content comprises determining that a user completed an activity associated with the review, wherein determining that the user completed the activity is based on the context-related parameters.

39. The non-transitory computer readable storage medium of claim 38, wherein the activity comprises an altered positioning of a first mobile device relative to a second mobile device and wherein detecting completion of the activity comprises detecting an increase in distance in relative position of the first mobile device with respect to the second mobile device beyond a distance threshold.

40. The non-transitory computer readable storage medium of claim 39, wherein completion of the activity further comprises detecting the increase in the distance beyond the distance threshold for a time period beyond a time threshold.

41. The non-transitory computer readable storage medium of claim 33, further comprising authenticating the user-specific context prior to generating a user interface to submit the review for the content.

42. The non-transitory computer readable storage medium of claim 33, further comprising generating a user interface to submit the review for the content, and initiating an unauthenticated review process if the user-specific context is not authenticated.

43. The non-transitory computer readable storage medium of claim 33, further comprising weighing the review for the content based on the user-specific context.

44. The non-transitory computer readable storage medium of claim 43, wherein the weighing the review comprises associating a higher weight with a group review than a non-group review, wherein the group review is the review generated by a first mobile device associated with a group activity.

45. The non-transitory computer readable storage medium of claim 44, wherein the group activity comprises associating the first mobile device with a group of mobile devices participating in the same activity as a group.

46. The non-transitory computer readable storage medium of claim 44, further comprising determining if a group performing the group activity is a known group by using social networking information or previously formed associations between the first mobile device and other mobile devices from the group and weighing the review for the group review based on information associated with the known group.

47. The non-transitory computer readable storage medium of claim 43, wherein weighing the review for the content based on the user-specific context of the review comprises:
determining reliability of the review for the content based on the user-specific context of the review; and
weighing the review based on the determined reliability of the review.

48. The non-transitory computer readable storage medium of claim 33, wherein the context-related parameter is selected from a group comprising determining frequency of visits to a location being reviewed, detecting time spent by a user reviewing the content, determining time of day at which the content is reviewed, determining completeness of the review of the content, determining consumability of the content that is being reviewed, determining user's past behavior while reviewing similar content, detecting eye gaze of the user to determine if the user was viewing the content, determining if a device is properly oriented towards the user for viewing of the content, determining location of the user, determining activity of the user is engaged in while reviewing the content, determining relation between the content and reviewer, and determining specificity of the review.

49. An apparatus for authenticating a user-specific context in a process to submit a review for content, the method comprising:
means for determining the user-specific context using one or more context-related parameters; and
means for authenticating that the user-specific context is a proper context for submitting the review for the content.

50. The apparatus of claim 49, wherein the one or more context-related parameters comprise at least a first context-related parameter indicative of a location of a first mobile device and a second context-related parameter indicative of a positioning of the first mobile device relative to a second mobile device, and wherein determining the user-specific context using the one or more context-related parameters comprises:
means for accessing the first context-related parameter indicative of the location of the first mobile device;
means for accessing the second context-related parameter indicative of a positioning of the first mobile device relative to the second mobile device; and
determining the user-specific context using the location of the first mobile device and the positioning of the first mobile device relative to the second mobile device.

51. The apparatus of claim 50, wherein the location is from a group consisting of location address, location name, location tag, location coordinates, and contextual information indicative of the location.

52. The apparatus of claim 49, wherein the content is from a group consisting of a location, a social gathering, a business, an activity at the business, an event, a local attraction, an article or a portion of the article, and a media clip or a portion of the media clip.

53. The apparatus of claim 49, wherein authenticating the review for the content comprises determining that a user performed an activity associated with the review, wherein determining that the user performed the activity is based on the context-related parameters.

54. The apparatus of claim 49, wherein authenticating the review for the content comprises means for determining that a user completed an activity associated with the review, wherein determining that the user completed the activity is based on the context-related parameters.

55. The apparatus of claim 54, wherein the activity comprises an altered positioning of a first mobile device relative to a second mobile device and wherein detecting completion of the activity comprises means for detecting an increase in distance in relative position of the first mobile device with respect to the second mobile device beyond a distance threshold.

56. The apparatus of claim 55, wherein completion of the activity further comprises means for detecting the increase in the distance beyond the distance threshold for a time period beyond a time threshold.

57. The apparatus of claim 49, further comprising means for authenticating the user-specific context prior to generating a user interface to submit the review for the content.

58. The apparatus of claim 49, further comprising means for generating a user interface to submit the review for the content, and initiating an unauthenticated review process if the user-specific context is not authenticated.

59. The apparatus of claim 49, further comprising means for weighing the review for the content based on the user-specific context.

60. The apparatus of claim 59, wherein the weighing the review comprises means for associating a higher weight with a group review than a non-group review, wherein the group review is the review generated by a first mobile device associated with a group activity.

61. The apparatus of claim 60, wherein the group activity comprises means for associating the first mobile device with a group of mobile devices participating in the same activity as a group.

62. The apparatus of claim 60, further comprising means for determining if a group performing the group activity is a known group by using social networking information or previously formed associations between the first mobile device and other mobile devices from the group and means for weighing the review for the group review based on information associated with the known group.

63. The apparatus of claim 59, wherein weighing the review for the content based on the user-specific context of the review comprises:
means for determining reliability of the review for the content based on the user-specific context of the review; and
means for weighing the review based on the determined reliability of the review.

64. The apparatus of claim 49, wherein the context-related parameter is selected from a group comprising determining frequency of visits to a location being reviewed, detecting time spent by a user reviewing the content, determining time of day at which the content is reviewed, determining completeness of the review of the content, determining consumability of the content that is being reviewed, determining user's past behavior while reviewing similar content, detecting eye gaze of the user to determine if the user was viewing the content, determining if a device is properly oriented towards the user for viewing of the content, determining location of the user, determining activity of the user is engaged in while reviewing the content, determining relation between the content and reviewer, and determining specificity of the review.
